(19) United States
(12) Patent Application Publication
(10) Pub. No.: US 2012/0117162 A1
(43) Pub. Date: May 10, 2012

(54) Methods and Social Media Portal Servers for Message Transmission

(75) Inventor: David McAleer, Montreal (CA)

(73) Assignee: TELEFONAKTIEBOLAGET L M ERICSSON (PUBL), Stockholm (SE)

(21) Appl. No.: 12/942,748

(22) Filed: Nov. 9, 2010

(51) Int. Cl. G06F 15/16

(52) U.S. Cl. 709/206

(57) ABSTRACT

Methods and social media portal servers are provided for facilitating the exchange of messages between portal servers of telecommunications networks. When a first user creates a message destined to a second user in a second telecommunications network via a first social media portal server servicing the first telecommunications network, the message is received by the second social media portal server that services the second telecommunications network including the second user, and the second portal server detects the message originated at the first social media portal server based on an indicator comprised in the message. Then, the second portal server inserts in the message a second short code associated with the second social media portal, or replaces the existing short code with a second short code, and sends the message comprising the second short code to a messaging center for delivery to the user, thus rendering the message with the second short code routable in the second telecommunications network. Alternatively, the first social media portal can insert the second short code in the message.

### TECHNICAL FIELD

The present invention relates to the area of social media portals.

### BACKGROUND

Over the last twenty years messaging systems have greatly evolved. The Short Messaging Service (SMS) provides the user of cellular networks with a very flexible manner of sending and receiving short text messages over cellular networks. In an evolution over SMS, the Multimedia Messaging Service (MMS) further allows users to exchange multimedia material, such as for examples pictures, video clips, or music, along text.

Social media portals like Facebook™ or Twitter™ further enhance messaging technologies with the possibility to quasi-instantly notify friends about a user status, user media posted on a social media portal server, or about a user location, by subscribing for receiving notifications from friends' activities.

Portals like Facebook™ and Twitter™ target the entire Internet community and therefore end up with a very large subscriber base. They can be accessed from any Internet-connected terminal, including laptops, personal computers, smart phones, etc. Other social media portals are only intended to serve subscribers of a given telecommunication network, such as for example in the context of a cellular telecommunication network providing its own social media portal servicing only users of that network. For example, a cellular telecommunications operator such as Rogers Canada may provide its users with access to a social media portal that only serves subscribers of the Rogers Canada's network. This social media portal may be further configured to access itself the Facebook™ or Tweeter™ accounts of the registered subscribers, performing a synchronisation of the portal's accounts with corresponding user accounts from other social media portals.

Reference is now been made to FIG. 1 (Prior Art), which shows a high level telecommunications network 100 implementing a social media portal server 108. Also shown in FIG. 1 are exemplary users A 102 and B 104, who are both subscribers of the social media portal server 108, which they use, for example, to upload and share with friends pictures, music, video, or related comments. The portal server 108 may also be connected to, or comprises, a social media database 110 that stores the uploaded pictures, music, video, and posted comments, and friends' connections. The network 100 also comprises a messaging system 106, such as for example an SMS-Center that is responsible for managing and distributing SMS messages in the network 100. When user B 104 accesses the portal server 108, such as for example via a web interface (not shown) of the portal, and posts into his account of the portal server 108 e.g. a picture, the picture becomes visible to other users of the portal 108, depending, for example upon the local configuration. In some instances, for example, the posted picture may only become available and visible to friends of the user B 104. Assuming that the picture is visible to user A 102 of the portal 108, user A may want to comment on that picture, and to post his own picture-related comment 101 on the same portal A 108, via a similar web interface. When the portal 108 receives the posted comment, it notifies user B 104 of the existence of the comment by creating a message destined to user B 104. Since the message originates at the media portal 108, the message may be an SMS message and comprises, in its origination field (e.g. a “FROM” field) a short code of the portal A 108.

A short code is an addressable identifier such as a short telephone number, usually consisting of a number of digits, which is used to address SMS and MMS messages from a mobile phone. Each common short code is typically designed to be unique to each telecommunications operator. Short codes are used for additional mobile services including television voting, polling, ordering ring tones, making donations and queries to special services, and may be billed at a different rate than SMS or MMS messages.

The SMS message 103 so-created for user B is then sent from the portal 108 to the messaging system 106 from where it is relayed to the user B 104. The SMS message for user B may comprise a link to the portal's related subject (or user account) in order to allow user B to not only be notified of the presence of user A's comments but also for providing at the same time an easy manner for user B to access the portal 108 by simply following (i.e. clicking) the provided link. This setup is common in the telecommunication industry where the telecommunication operators provide their own social media portals in order to service their own subscriber's base. One of the advantages of such a set up is that it generates SMS traffic in the network 100 when user notifications alike the message 103 are being sent from the portal A 108, which further creates new accesses of the portal 108, thus increasing the portal's visibility and advertising revenues. For example, User B may come back to the portal and post a follow up comment. This increases usage and enables dialog between the users.

A problem exists though with the network 100 as described in FIG. 1 because it only serves one network. For example, if user B 104 was located in another network, he/she could not connect to the portal A 108 since the later is only servicing users of the network 100. Likewise, the SMS message notifications sent from the portal server 108 towards another network's user B cannot reach the later, because that message comprises a short code that is only routable inside the network 100. These problems limit the use by network operators of social media portals alike the portal 108 and hinders the growth of their related revenues, since user B is prevented from being notified of the existence of a comment from user A which could have generated a user dialog, and contribute to the network's traffic.

Accordingly, it should be readily appreciated that in order to overcome the deficiencies and shortcomings of the existing solutions, it would be advantageous to have a solution for flexibly and efficiently exchange messages originated by a social media portal across more than one network. The present invention provides such methods and social media portal servers.

### SUMMARY

In one aspect, the invention provides for a method for sending a message from a first social media portal server serving a first telecommunications network to a second social media portal server serving a second telecommunications network, and further to a user of the second network. The method starts by receiving at the second social media portal server a message and detecting at the second social media portal server that the message originated at the first social media portal server based on an indicator comprised in the message. Then, a second short code associated with the second social media portal is inserted in the message, and message comprising the second short code associated with the second social media portal server is sent to a messaging center for delivery to the user, wherein the message with the second short code associated with the second media portal server is routable in the second network.

In another aspect, the invention provides for a method for sending a message from a first social media portal server serving a first network to a second social media portal server serving a second telecommunications network, and further to a user of the second telecommunications network. The method starts by creating at a first social media portal server a message destined to a user in a second telecommunications network served by a second social media portal server, the message comprising a FROM field set to a short code associated with the first media portal server, and further detecting at the first social media portal server that the user is served by the second telecommunications network. The method further allows for replacing in the message the first short code with a second short code associated with the second social media portal server; and for sending the message comprising the FROM field with the second short code associated with the second social media portal server to the second social media portal server for delivery to the user, wherein the message with the second short code associated with the second media portal server is routable in the second telecommunications network.

In yet another aspect, the invention provides for a second social media portal server for serving a second telecommunications network, the server comprising a processor, a communication interface operationally connected to the processor, and an instructions repository comprising instructions that when executed by the processor cause the later, when receiving a message via the communication interface, to detect based on an indicator comprised in the message that the message originated at a first social media portal server, and to further insert in the message a second short code associated with the second social media portal server, and to yet further send the message comprising the second short code associated with the second social media portal server to a messaging center for delivery to a user of the second network. The message with the second short code associated with the second media portal server is routable in the second telecommunications network and first social media portal server serving a first network.

In yet another aspect, the invention provides for a first social media portal server serving a first network, the server comprising a processor, a communication interface operationally connected to the processor; and an instructions repository comprising instructions that when executed by the processor cause the later to create a message destined to a user in a second network served by a second social media portal server, the message comprising a FROM field set to a short code associated with the first media portal, and to further detect that the user is served by the second telecommunications network and to replace in the message the first short code with a second short code associated with the second social media portal server, the processor further sending via the communication interface the message comprising the FROM field set to the second short code associated with the second social media portal server to the second social media portal server for delivery to the user. The message with the second short code associated with the second media portal server is routable in the second network.

### DRAWINGS

For a more detailed understanding of the invention, for further objects and advantages thereof, reference can now be made to the following description, taken in conjunction with the accompanying drawings, in which:

FIG. 1 (Prior Art) shows a high level network of a known prior art implementation of a social media portal in a telecommunications network;

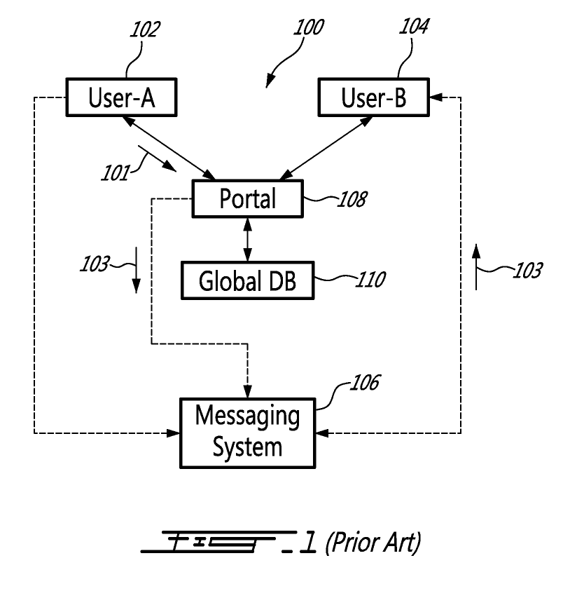

FIG. 2 shows a high level network of an exemplary preferred embodiment of the invention providing multiple social media portal servers in a telecommunications network;

FIG. 3.a shows a nodal operation and signal flow diagram of another exemplary preferred embodiment of the invention providing multiple social media portal servers in a telecommunications network;

FIG. 3.b shows a nodal operation and signal flow diagram of another variant of an exemplary preferred embodiment of the invention providing multiple social media portal servers in a telecommunications network; and

FIG. 4 shows a high level node diagram of an exemplary implementation of a social media portal server according to the preferred embodiment of the invention.

### DETAILED DESCRIPTION

The innovative teachings of the present invention will be described with particular reference to various exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views.

The present invention provides for methods and social media portals for seamlessly exchanging messages generated via social media portal servers, such as for example SMS notification messages, across telecommunications networks. The invention allows for sending a message from a first social media portal server serving a first telecommunications network (e.g. in a given first country) to a second social media portal server serving a second telecommunications network (e.g. in another second country), and further to a user of the second telecommunications network.

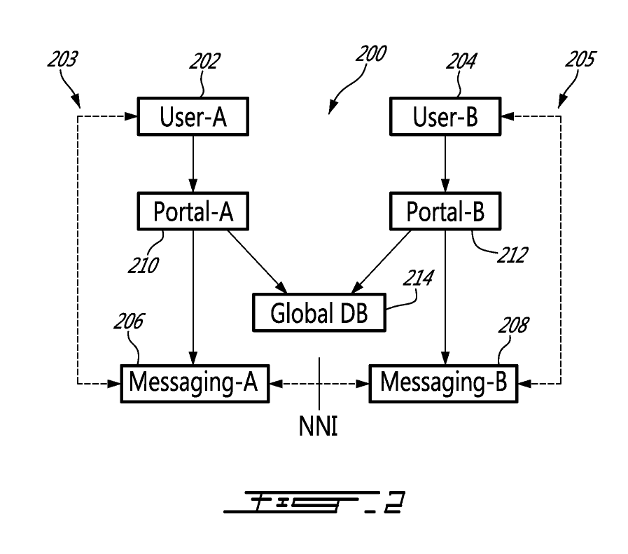

Reference is now being made to FIG. 2, which shows a high level network of an exemplary preferred embodiment of the invention providing multiple social media portal servers in a communication network comprising first and second telecommunications networks 203 and 205. In FIG. 2, the users A 202 and B 204 are served by the networks 203 and 205 respectively. The social media portal server A 210 services the first telecommunications network 203 and its users, alike the exemplary user A 202, while the social media portal server B 204 services users of the network 205 alike the exemplary user B 204. The portal servers provide connectivity for the users to the social media portal global database 214 that stores their media and status, e.g. their pictures, music, video, presence status, etc. The portal servers 210 and 212 may further allow users to create groups of friends and share their data there between. Each telecommunications network 203 and 205 has its own messaging system 206 and 208 respectively, where each such messaging system services one of the telecommunications networks 203 and 205 and users therein. The messaging systems A 206 and B 208 may be SMS centers connected with each other via a network-to-network interface (NNI) and the telecommunications networks 203 and 205 may be cellular telecommunications networks.

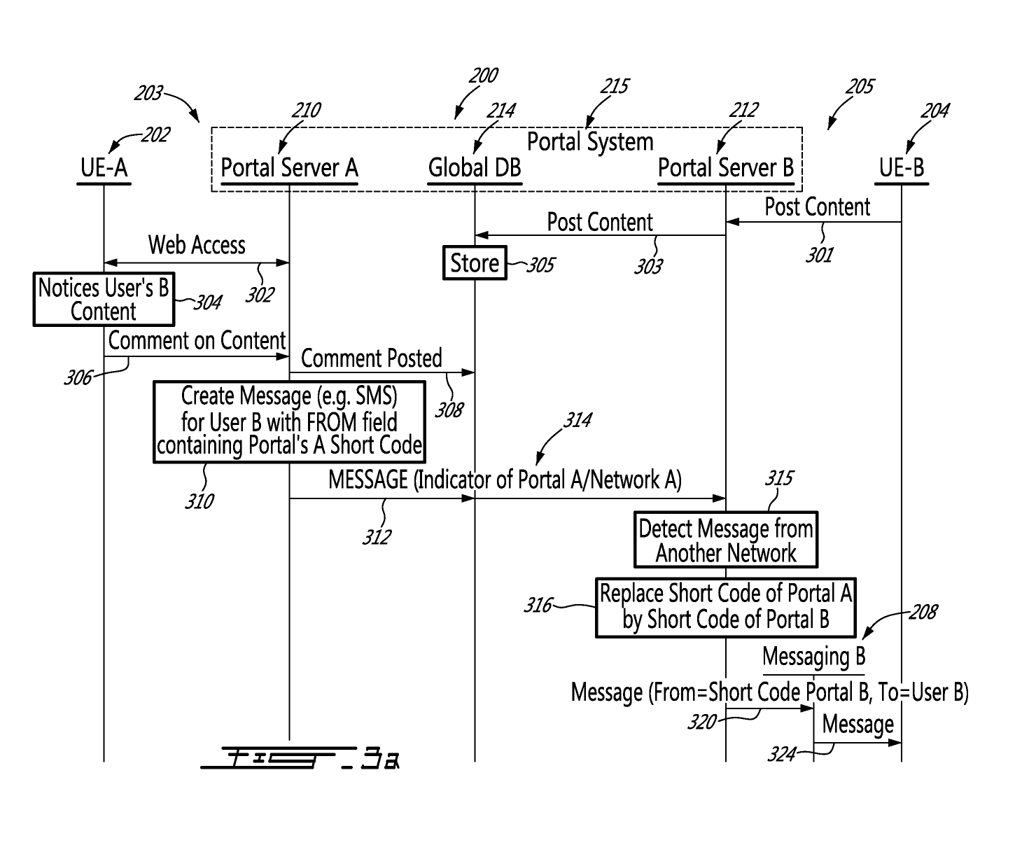

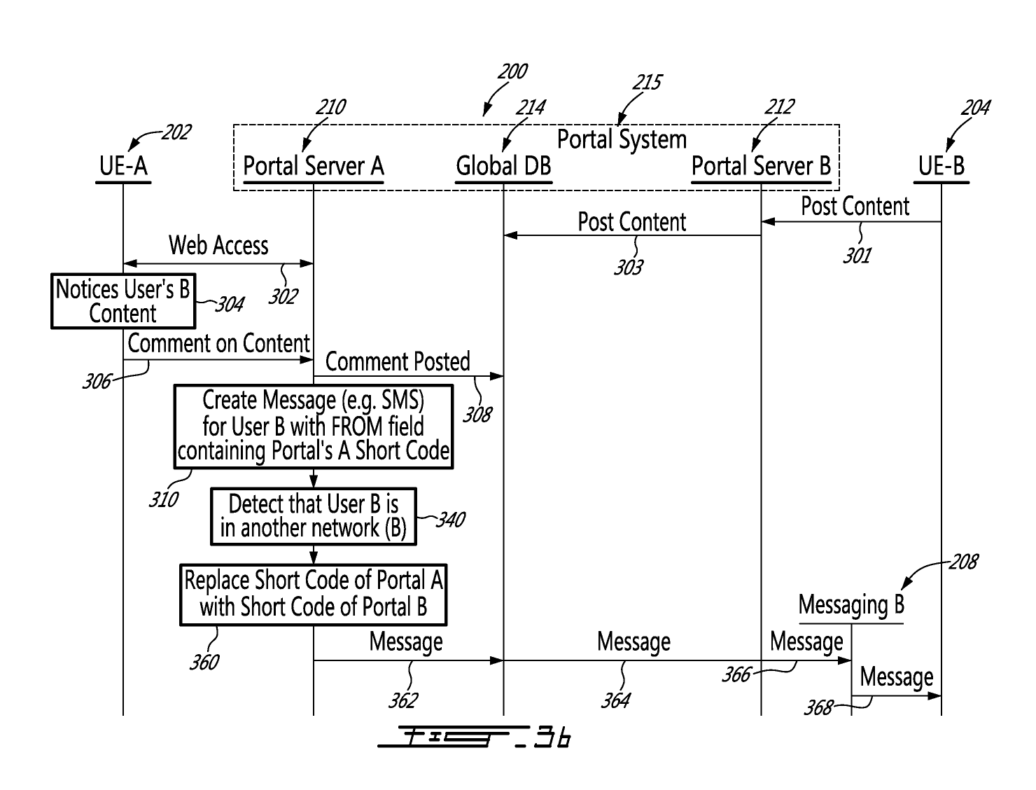

Reference is now made jointly to FIG. 2 as previously described, and to FIG. 3.a, which shows a nodal operation and signal flow diagram of an exemplary preferred embodiment of the invention. FIG. 3.a shows substantially the same elements described hereinbefore in relation to FIG. 2, which are designated via similar numerals. Portal servers 210 and 212, as well as the global database 214 is also shown and being part, optionally, of a same social media system 215 (as shown in dotted lines) that may be operated by a same network operator. In the exemplary scenario described herein, the user B 204 posts media content (e.g. a picture) on the social media portal server B 212, action 301. This may be achieved by the user B 204 connecting via his/her own terminal (e.g. a mobile terminal) to the portal server B 212 and uploading a picture thereto. In action 303, the content is relayed from the social media portal server A 212 to the global database 214, where it is stored in action 305, and as a consequence it becomes visible to other users, such as for example to user A 202. Later, user A 202 accesses the social media portal server A 210 e.g. via a web access 302 performed, for example, from his/her own mobile terminal, and in action 304 notices the content uploaded by user B 204. Assuming the user A 202 likes the picture, he/she wants to post a comment related to the picture and, for this purpose, in action 306, the user A 202 comments on the picture content via a web access to the social media portal server A 210. For example, the comment of the user A can be “I like your picture. Funny!”. The posted comment is relayed to and stored onto the database 214, action 308. According to the present preferred embodiment of the invention, the social media portal server A 210 may be configured to further act to notify user B 204 of the existence of the new comment. For this purpose, in action 310, the social media portal server 210 creates a message intended for user B 204, such as for example an SMS message, that may comprise a notification part for notifying of the existence of the posted comment, and a web link part pointing to the comment itself for allowing user B 204 to easily access the part of the portal server that relates to the comment (and content). Because it is generated by the social media portal server A 202, the message for notifying user B 204 also comprises an indicator 314 indicating that the message originates from the social media portal server 210. Such an indicator may comprise, or consist of, a short code associated with the portal server A 210 and the short code maybe stored in a “From” field of the SMS message. Such a short code, because associated with the social media portal server 210 may be only routable within the telecommunications network 210. According to the present exemplary embodiment of the invention, in action 312, the SMS message along with the indicator 314 is sent from the portal server A 210 to the portal server B 212. Upon receipt of the message, the portal sever B 212 detects that the message comes from outside the network 205, based, for example, on the indicator 314. If the message comprises the short code associated with portal A 210, then the short code may be used as the indicator to determine in action 315 that the message comes from another network and therefore it is not routable in the local network 205. As a consequence, in action 316 the social media portal B 212 replaces the received short code of the portal server A 210 with a short code of portal B 212 by for example inserting the second short code in the message, the second short code being routable via the telecommunications network 205 to the user B 204. Once the message is provided with the short code of the portal server B 212, it is sent in action 320 to the messaging center 208 for the message to be further delivered to the user B 204 in action 324. The user B 204 is thus alerted via the message of action 324 of the existence of the comment posted on his/her picture and is thus given an opportunity to develop a dialog with user A 202.

Reference is now made jointly to FIGS. 2, 3.a as previously described, and further to FIG. 3.b, which shows a nodal operation and signal flow diagram of another variant of an exemplary preferred embodiment of the invention providing multiple social media portal servers in a telecommunications network. Shown in FIG. 3.b are the same nodes 202-215 of the network 200, and the same initial actions 301-310. However, according to the variant described in FIG. 3.b, some actions described in FIG. 3.a as occurring in the portal server B 204 may be implemented on the side of the portal server A 210. The message to notify user B 204 of the comment posted by user A 2102 in actions 306-308 is created in action 310 as described in FIG. 3.a. The portal server A 210 may then be configured to create a certain type of message by default, e.g. an SMS message with the “FROM” field set to the portal A server's own short code. In action 350, the portal server A 210 may further detect that the intended recipient of the newly created message is served, or resides in another telecommunications network, i.e. in the telecommunications network 205. This may be accomplished using the MSISDN (Mobile Subscriber Integrated Services Digital Network Number, or any other identifier) of user B 204 that may be provided to the portal server A 210. Knowing the user B 204 is in network B 204, in action 360, the portal server A 210 replaces its own short code in the “FROM” field of the message with a short code of the portal server B 204, by inserting the short code of the social media portal server B 212 in the message. The later is a short code that is routable in the network 205. The updated message is then sent in action 362-264 to the portal server B 212, and from there, in action 366, to the messaging system B 208. Since the short code now found in the message is routable within the network 205, the messaging system 208 recognises the short code provided in the “FROM” field of the message, and further sends the message to the intended recipient, i.e. to user B 204, in action 368. User B 204 is thus notified of the existence of the comment posted by user A 202, which may trigger additional responses and messaging interactions between the two users, therefore contributing to creation of traffic and revenue generation for the shown network(s).

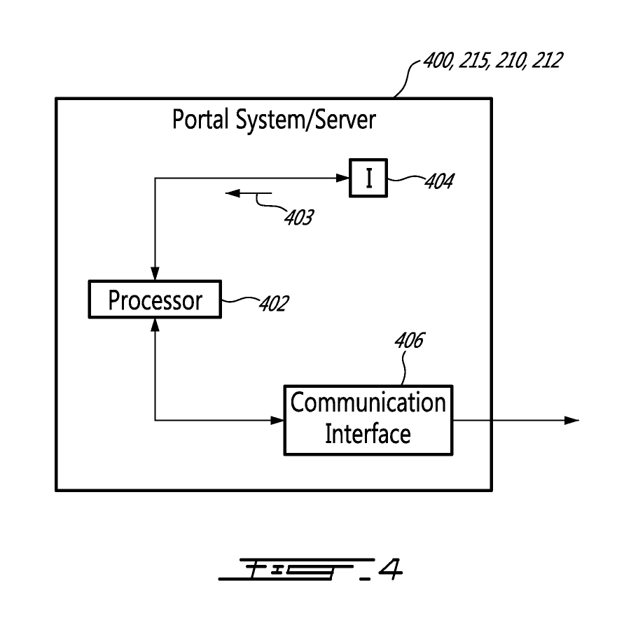

Reference is now made to FIG. 4, which shows a high level node diagram of an exemplary implementation of a social media portal server according to a preferred embodiment of the invention. Show in FIG. 4 is an exemplary implementation of a social media portal server 400 alike the previously described portal servers 210 and 212. The social media portal server 400 may comprise a communication interface 406 operationally connected to a processor 402, that executes instructions 403 stored on an instructions repository 404. The instructions, when executed, cause the processor to perform, alone or in combination with the communications interface 406, the actions described in FIGS. 2, 3.a, and 3.b relative to the social media portal servers 210 and 212.

For example, assuming that the social media portal server 400 implements the functionality of the portal server 212 of FIG. 3.a, the instructions repository may comprise instructions that when executed by the processor 402 cause the later, when receiving a message via the communication interface 406, to detect based on the indicator 314 comprised in the message that the message originated at a first social media portal server (e.g. the server 210) of another telecommunications network, and to further insert in the message a second short code associated with the second social media portal server (e.g. the server 212), and to yet further send the message comprising the second short code associated with the second social media portal (e.g. the server 212) to the messaging center 208 for delivery to the user B 204 of the second telecommunications network (e.g. network 205). The message with the second short code associated with the second media portal server is routable in the second telecommunications network.

In another example, assuming that the social media portal server 400 implements the functionality of the portal server 210 of FIG. 3.b, the instructions repository may comprise instructions that when executed by the processor 402 cause the later to create a message destined to user B 204 of the second network (e.g. network 205) served by the second social media portal server (e.g. server 212), the message comprising a “FROM” field set to a short code associated with the first media portal server (e.g. server 210), and to further detect that the user B 204 is served by the second network (e.g. network 205) and to replace in the message the first short code with a second short code associated with the second social media portal server (e.g. server 212), the processor further sending via the communication interface 406 the message comprising the “FROM” field set to the second short code associated with the second social media portal server (e.g. the server 212) to the second social media portal server for delivery to the user B 204. The message with the second short code is routable in the second network.

Based upon the foregoing, it should now be apparent to those of ordinary skills in the art that the present invention provides an advantageous solution, which offers a simple yet flexible and efficient manner of obtaining sensed data from sensor nodes. Although the system and method of the present invention have been described with particular reference to certain type of messages and nodes, it should be realized upon reference hereto that the innovative teachings contained herein are not necessarily limited thereto and may be implemented advantageously in various manners. It is believed that the operation and construction of the present invention will be apparent from the foregoing description. While the method and system shown and described have been characterized as being preferred, it will be readily apparent that various changes and modifications could be made therein without departing from the scope of the invention as defined by the claims set forth hereinbelow.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

1. A method for sending a message from a first social media portal server serving a first telecommunications network to a second social media portal server serving a second telecommunications network, and further to a user of the second network, the method comprising:
receiving at the second social media portal server a message;
detecting at the second social media portal server that the message originated at the first social media portal server based on an indicator comprised in the message;
inserting in the message a second short code associated with the second social media portal; and
sending the message comprising the second short code associated with the second social media portal server to a messaging center for delivery to the user;
wherein the message with the second short code associated with the second media portal server is routable in the second network.

2. The method as in claim 1, wherein the indicator comprises a FROM field of the message set to a first short code associated with the first social media portal, wherein the message with the FROM field set to the first short code associated with the first social media portal server is not routable in the second network.

3. The method as in claim 2, wherein the step of inserting a second short code int eh message comprises replacing in the FROM field of the message the first short code associated with the first social media portal server with the second short code associated with the second social media portal server.

4. The method as in claim 2, further comprising the step of creating the message at the first social media portal server, the message being destined to the user of the second network, the message comprising the FROM field set to the first short code associated with the first social media portal server.

5. The method as in claim 1, wherein the first social media portal server serves the first network in a first country and the second social media portal server serves the second network in a second country, wherein first and second social media portal servers are part of a social media portal system operated by a same network operator.

6. A method for sending a message from a first social media portal server serving a first network to a second social media portal server serving a second telecommunications network, and further to a user of the second telecommunications network, the method comprising:
creating at a first social media portal server a message destined to a user in a second telecommunications network served by a second social media portal server, the message comprising a FROM field set to a short code associated with the first media portal server;
detecting at the first social media portal server that the user is served by the second telecommunications network;
replacing in the message the first short code with a second short code associated with the second social media portal server; and
sending the message comprising the FROM field with the second short code associated with the second social media portal server to the second social media portal server for delivery to the user;
wherein the message with the second short code associated with the second media portal server is routable in the second telecommunications network.

7. The method as in claim 6, wherein the message with the FROM field with the first short code associated with the first social media portal server is not routable in the second network.

8. The method as in claim 6, wherein the first social media portal server serves the first network in a first country and the second social media portal server serves the second network in a second country, wherein first and second social media portal servers are part of a social media portal system operated by a same network operator.

9. A second social media portal server for serving a second telecommunications network, the server comprising:
a processor;
a communication interface operationally connected to the processor; and
an instructions repository comprising instructions that when executed by the processor cause the later, when receiving a message via the communication interface, to detect based on an indicator comprised in the message that the message originated at a first social media portal server, and to further insert in the message a second short code associated with the second social media portal server, and to yet further send the message comprising the second short code associated with the second social media portal server to a messaging center for delivery to a user of the second network;
wherein the message with the second short code associated with the second media portal server is routable in the second telecommunications network and first social media portal server serving a first network.

10. The second social media portal server as in claim 9, wherein the indicator comprises a FROM field of the message set to a first short code associated with the first social media portal server, wherein the message with FROM field set to the first short code associated with the first social media portal server is not routable in the second network.

11. The second social media portal server as in claim 10, wherein when the processor inserts in the message the second short code associated with the second social media portal server, the processor replaces in the FROM field of the message the first short code associated with the first social media portal with the second short code associated with the second social media portal server.

12. The second social media portal server as in claim 9, wherein the first social media portal server serves the first telecommunications network in a first country and the second social media portal server serves the second telecommunications network in a second country, wherein first and second social media portal servers are part of a social media portal system operated by a same network operator.

13. A first social media portal server serving a first network, the server comprising:
a processor;
a communication interface operationally connected to the processor; and
an instructions repository comprising instructions that when executed by the processor cause the later to create a message destined to a user in a second network served by a second social media portal server, the message comprising a FROM field set to a short code associated with the first media portal, and to further detect that the user is served by the second telecommunications network and to replace in the message the first short code with a second short code associated with the second social media portal server, the processor further sending via the communication interface the message comprising the FROM field set to the second short code associated with the second social media portal server to the second social media portal server for delivery to the user;
wherein the message with the second short code associated with the second media portal server is routable in the second network.

14. The first social media portal server as in claim 13, wherein the message with the FROM field comprising the first short code associated with the first social media portal server is not routable in the second network.

15. The first social media portal server as in claim 13, wherein the first social media portal server serves the first telecommunications network in a first country and the second social media portal server serves the second telecommunications network in a second country, wherein first and second social media portal servers are part of a social media portal system operated by a same network operator.
